(19) United States
(12) Patent Application Publication
(10) Pub. No.: US 2004/0131717 A1
(43) Pub. Date: Jul. 8, 2004

(54) Rotary compression molding machine

(76) Inventors: Keiji Shimada, Kyoto (JP); Kenji Harada, Kyoto (JP); Yuichi Ozeki, Aichi (JP); Yoshiya Kondo, Aichi (JP); Yukinao Watanabe, Aichi (JP)

Correspondence Address: BANNER & WITCOFF, 1001 G STREET N W, SUITE 1100, WASHINGTON, DC, 20001, US

(21) Appl. No.: 10/476,575

(22) PCT Filed: May 2, 2002
(86) PCT No.: PCT/JP02/04418

(30) Foreign Application Priority Data
May 7, 2001 (JP) 2001-135866

(51) Int. Cl. B30B 11/08

(52) U.S. Cl. 425/345; 425/416; 425/418; 425/353

(57) ABSTRACT

This invention provides a rotary compression molding machine suitable for manufacture of a core-incorporated molded article, wherein: at least an upper punch comprises a center punch and an outer punch, both of which are slidable and capable of pressing, the upper center punch having a head part capable of projecting from a head part of the upper outer punch, the rotary compression molding machine including: a plurality of powdery/granular material feeding and filling sections; guide means for guiding the center punch and the outer punch either separately or as one unit; an upper pre-compression roll operative to press the center punch or both the center punch and the outer punch; lower pre-compression means making a pair with the upper pre-compression roll; engagement means for causing the upper center punch to engage the upper outer punch with the head part of the upper center punch in a state projecting maximally from the head part of the upper outer punch to allow the upper center punch and the upper outer punch to operate together as one unit; an upper main compression roll operative to press the upper center punch and the upper outer punch turned into one unit by engagement therebetween; and lower main compression means making a pair with the upper main compression roll.

### TECHNICAL FIELD

The present invention relates to a rotary compression molding machine and a punch for use therein, which are capable of manufacturing molded articles of the type incorporating therein a molded core formed from a material different from a material forming an outer layer, such as so-called dry coated tablets.

### BACKGROUND ART

In such industrial fields of pharmaceuticals, foods and electronic components, rotary compression molding machines of the type called rotary tablet machines are being heavily used in manufacturing molded articles by compressing powdery/granular materials. Among such molded articles those articles of the type incorporating therein a molded product molded from a different material, which is called a core, are used in the field of pharmaceuticals mainly. Such a molded article incorporating a core is called “dry coated tablet” in the field of pharmaceuticals since it is manufactured by compression-molding a powdery/granular material to form an outer layer embracing the core tablet (center tablet).

Since such a dry coated tablet incorporating a core tablet therein is capable of reducing the probability of contact between the ingredients of the core and those of the outer layer, an improvement in stability can be expected by virtue of a decrease in the interaction between the ingredients. Further, the dry coated tablet is utilized in masking the bitterness of a core tablet or enhancing the aesthetic of the outward appearance of a tablet and applied to controlled release preparations and the like.

A conventional process for manufacturing such a molded article incorporating a core therein includes: previously preparing a core as a molded product; feeding the core in the bore of a die which has been previously filled with an outer layer powdery/granular material; and further feeding the outer layer powdery/granular material into the die bore, followed by compressing molding. In this case, the core is previously prepared using another rotary compressing molding machine and then fed into the die bore of a typical rotary compression molding machine for further compression molding. Therefore, the upper and lower punches used in the typical rotary compression molding machine are similar to those used for manufacturing an ordinary molded article having no core.

With the above-described process, however, a powdery/granular material that will form the core has to be compression-molded prior to the molding of the aimed article and, in addition, feeding of the core thus molded is needed. Thus, this process involves serious problems of a larger amount of operation and lower production efficiency than the process for manufacturing an ordinary compression-molded article having no core. Further, with the conventional process including feeding of a core as a molded product, molded products that will become cores are fed one by one into the bores of dies fitted in a rotary table rotating at a high velocity, which may cause a failure to feed a core into a die bore or may cause excessive feeding of cores contrarily. Such a failure to feed or excessive feeding is likely to raise a problem that an abnormal dry coated tablet which is coreless or has plural cores is produced undesirably, which necessitates complicated mechanisms or devices for monitoring core feeding and inspecting final molded articles for the purpose of guaranteeing the product quality. Such inspection mechanisms or devices are becoming upsized and more complicated inconveniently.

Further, in the conventional process including feeding of cores it is essential to place a core horizontally at a center position in a mass of the outer layer powdery/granular material filled in a die bore. If the core is positioned off the center, the resulting outer layer becomes thin at that part. This results in lowered moldability, which is likely to lead to molding faults including capping, i.e. peeling off of a surface layer of a resulting molded article, and lamination, i.e. cracking of a molded article in a layered fashion.

For the prevention of such deviated centering of a core due to centrifugal force on the rotary table, there are disclosed a method of visually checking core centering after feeding of a core, a device provided with a multiple optical axes color discrimination sensor for automatically correcting the core position in cooperation with a core feeding device, and a method of preventing deviation of core centering by utilizing a device for automatically correcting the core feeding position based on information obtained by a CCD image pick-up device in Japanese Patent Laid-Open Publications No. SHO 55-48653, No. SHO 61-60298 and No. HEI 9-206358, respectively.

However, a conventional dry coating machine, even if combined with the aforementioned core centering device, usually has a difficulty in operating at high-velocity revolution (40 to 60 rpm) at which a common compressing machine is operable due to problems associated with core centering precision, core feed stability and the like. Actually, such a conventional dry coating machine is operable at about 30 rpm at most. Therefore, the production efficiency of the conventional dry coating machine cannot but be said to be low.

With respect to the size of a molded article incorporating a core, the conventional process requires that the thickness of the outer layer of the molded article be at least 1 to 1.5 mm in view of deviations in core centering and insufficient bond strength between the core and the outer layer. Accordingly, such a molded article, as a whole, is necessarily larger by at least 2 to 3 mm than the profile of the core. Thus, a core-incorporated molded article tends to become larger than a common molded article, which is an impediment to downsizing of such a molded article.

The conventional process including feeding of cores from outside requires that an exclusive feeding device tailored to the shape of a core to be used be designed. For this reason, when molded articles are to be manufactured using cores of different shapes, core feeding devices of different types become necessary, which inevitably limits the degree of freedom in selecting core shapes.

Further, since the conventional process includes feeding of previously prepared cores, such cores need to ensure such molding characteristics as to withstand the transfer thereof through the feed path to a die bore and such a shape as to allow the transfer thereof to be achieved smoothly. For this reason, there are many limitations on the shape and physical properties of such a core. Stated otherwise, it is absolutely impossible for the conventional process to manufacture a molded article incorporating a core that is not molded into a solid, for example a core left in a powdery/granular state.

In actual compression molding with a rotary compression molding machine, a powdery/granular material fed into a die bore is molded by compression from above and below with punches in a sandwiched fashion. Punches of various shapes are used in accordance with shapes of aimed molded articles to be compression-molded. Use of special punches is required in some cases. In manufacturing, for example, a troche-type molded article having a hollowed-out central part for use in the industrial field of pharmaceuticals, it is difficult for common punches to fill a powdery/granular material uniformly. Further, since such a molded article has a hollow part in the center, compression molding for producing such an article employs a double punch so-called “ring punch”.

In manufacturing a very small molded article having a complicated shape used for various applications such as electronic components, differences in compression ratio for a powdery/granular material due to such a complicated shape may yield a molded article having parts with their respective powdery/granular material densities largely different from each other. As a result, the molded article thus obtained may be cracked or chipped. To overcome these problems a method is employed to compress a powdery/granular material into a molded article having a uniform density of the powdery/granular material with use of a multi-structure punch having a structure similar to that of a ring punch as used for the lower punch mechanism of a rotary compression molding machine described in Japanese Patent Laid-Open Publication No. SHO 52 -126577 by moving a lower center punch and a lower outer punch separately.

However, such conventional punches of the type having a multiple structure, which are called ring punches, are used only as lower punches for the purpose of assisting in filling a powdery/granular material or ensuring the formation of a ring-shaped hollow, or for like purposes and hence are used in lower punches. In the majority of such cases, the center punch included in such a ring punch is of stationary type.

As described above, in manufacturing a molded article incorporating a core, the prior art involves various problems including those associated with productivity, cost, occurrence of a molded article having no core or plural cores, centering of a core following feeding, core deviations due to centrifugal force of a rotary table, occurrence of molding failures resulting therefrom, and limitations on the shape of a core.

Though International Laid-Open Publication No. WO 01/98067 discloses a method of manufacturing a core-incorporated molded article from two kinds of powdery/granular material without using a molded core, the structure of a punch used to practice the method, the mechanism for pressing the punch, and the like are complicated.

### DISCLOSURE OF INVENTION

The object of the present invention is to solve the foregoing problems. To attain this object, the present invention comprises improvements made to the invention described in the aforementioned International Laid-Open Publication and provides the following means.

A rotary compressing molding machine according to the present invention is an apparatus capable of manufacturing a molded article incorporating a core, which includes: upper and lower punches, at least the upper punch having a double structure comprising a center punch and an outer punch around the outer periphery of the center punch; guide means for guiding the center punch and the outer punch either separately or as one unit; means for enabling the center punch and the outer punch to perform a compressing operation; and feeding sections operative to feed a powdery/granular material for the core and a powdery/granular material for an outer layer, respectively, and a compression molding section operative to compression-mold the powdery/granular material for the core and/or the powdery/granular material for the outer layer, the feeding sections and the compression molding section being provided on a same rotary table. When expressed with its essential parts only, the rotary compressing molding machine is of the following construction.

That is, the present invention provides a rotary compression molding machine wherein: a rotary table is rotatably disposed in a frame; dies each having a die bore are mounted to the rotary table at a predetermined pitch; an upper punch and a lower punch are vertically slidably held above and below each of the dies; and a powdery/granular material filled in the die bore is compression-molded when respective punch tips of upper and lower punches in a state inserted in the die bore pass through between an upper roll and a lower roll, the rotary compression molding machine being characterized in that at least the upper punch comprises a center punch and an outer punch around the center punch, both of which are slidable and capable of pressing, the upper center punch having a head part capable of projecting from a head part of the upper outer punch, and characterized by comprising: two or three or more powdery/granular material feeding and filling sections; guide means for guiding the center punch and the outer punch either separately or as one unit; an upper pre-compression roll operative to press the center punch or both of the center punch and the outer punch guided by the guide means; lower pre-compression means making a pair with the upper pre-compression roll; engagement means for causing the upper center punch to engage the upper outer punch with the head part of the upper center punch in a state projecting maximally from the head part of the upper outer punch to allow the upper center punch and the upper outer punch to operate together as one unit; an upper main compression roll operative to press the upper center punch and the upper outer punch turned into one unit by engagement therebetween caused by the engagement means; and lower main compression means making a pair with the upper main compression roll.

In a preferred specific embodiment, the rotary compression molding machine of the present invention is characterized in that at least the upper punch comprises a center punch and an outer punch around the center punch, both of which are slidable and capable of pressing, the upper center punch having a head part capable of projecting from a head part of the upper outer punch, and characterized by comprising: powdery/granular material feeding and filling sections for a first powdery/granular material, a second powdery/granular material and a third powdery/granular material, respectively; guide means for guiding the center punch and the outer punch either separately or as one unit; an upper pre-compression roll operative to press the center punch or both the center punch and the outer punch guided by the guide means to compress the first powdery/granular material and/or the second powdery/granular material filled in the die bore; a lower pre-compression roll making a pair with the upper pre-compression roll; engagement means for causing the upper center punch to engage the upper outer punch with the head part of the upper center punch in a state projecting maximally from the head part of the upper outer punch to allow the upper center punch and the upper outer punch to operate together as one unit; an upper main compression roll operative to press the upper center punch and the upper outer punch turned into one unit by engagement therebetween caused by the engagement means with the die bore in a state filled with the third powdery/granular material after completion of the pressing operation of the pre-compression rolls; and a lower main compression roll making a pair with the upper main compression roll.

At this point, the pre-compression rolls preferably include two pairs of pre-compression rolls consisting of a pair of pre-compression rolls for compressing the first powdery/granular material and a pair of pre-compression rolls for compressing the second powdery/granular material (or the first and second powdery/granular materials).

With the construction like this, at least the upper outer punch and the upper center punch slide by the guide means and the pre-compression rolls press the upper center punch to cause the upper center punch or both the upper center punch and the upper outer punch to compress the first powdery/granular material and/or the second granular material. Then, the center punch and the outer punch are made operable together as one unit by the engagement means and are caused to pass through between the main-compression rolls, thereby compressing the third powdery/granular material filled into the die bore with the center punch and the outer punch after the pre-compression.

By this means, feeding plural kinds of powdery/granular material separately and then compression-molding them separately or together, it becomes possible to manufacture a core-incorporated molded article. With the machine of the present invention, there is no need to feed a molded product as a part that will form the core of the aimed molded article and, hence, the mechanism for feeding such molded products can be eliminated. Also, there is no need to perform centering of such a molded product within the die bore and, hence, it is possible to obviate the occurrence of a defective article due to deviation of the position of a molded product to be incorporated in the aimed molded article. Thus, the machine of the present invention can have a simplified structure and offer enhanced production efficiency with improved yield. Further, since the center punch of the punch employing the double structure is configured to mold the core part of the aimed molded article, the core will not deviate from its right position.

It is to be noted that the term “powdery/granular material” as used in the description of the instant application is meant to include powder, granule and analogs thereto unless the term “powder” is used particularly according to common usage. The term “upper center punch” indicates the center punch included in an upper punch, and such an expression is frequently applied to other punches.

The aforementioned first, second and third powdery/granular materials are for an outer layer, a core, and an outer layer, respectively. In manufacturing an ordinary core-incorporated molded article (dry coated tablet), the first powdery/granular material and the third powdery/granular material are the same, though different powdery/granular materials may be used when required. These powdery/granular materials are fed and filled by means of respective powdery/granular material feeding and filling devices, such as open feed shoes or mixing feed shoes, constituting the powdery/granular material feeding and filling sections.

In the rotary compression molding machine of the present invention the lower punch may consist of an ordinary punch which does not have a double structure. Preferably, however, the lower punch also has a double structure comprising a center punch and an outer punch around the center punch, both of which are slidable and capable of pressing. In the case where the lower punch is also given the double structure, it is needless to say that the machine is provided with guide means for guiding the lower center punch and the lower outer punch either separately or as one unit and lower compression means at a location corresponding to the location of the upper compression roll. There is no particular limitation on the lower compression means as long as it is disposed so as to be vertically position-changeable and is capable of smoothly guiding the lower punch and reliably supporting the lower punch during compression of the powdery/granular materials. Examples of such lower compression means include an arrangement of plural bearings or the like or a rail or the like. Advantageously, the lower compression means comprises a lower compression roll operative to press the lower center punch and the lower outer punch either separately or as one unit. In some cases the lower compression means making a pair with the upper compression roll is provided for each of the lower center punch and the lower outer punch.

As for the lower punch having the double structure, its center punch and outer punch are preferably arranged as follows. That is, the lower center punch has a head part configured to be capable of projecting from a lower end of the lower outer punch and engagement means is provided to cause the lower center punch in a state retracted most deeply into the lower outer punch to engage the lower outer punch to allow the lower center punch and the lower outer punch to operate together as one unit. With this arrangement, the lower pre-compression roll is operative to press only the lower center punch in a state out of engagement with the lower outer punch, while the lower main compression roll is operative to press the lower center punch and lower outer punch in a state engaged with each other as one unit by the engagement means.

A specific example of the engagement means for engaging the upper center punch and the upper outer punch with each other or for engaging the lower center punch and the lower outer punch with each other comprises an engaging part located adjacent to a center punch head part to engage an outer punch, and an outer punch engaging part located at the outer punch to engage the engaging part of the center punch.

The center punch and the outer punch preferably operate together as one unit in order to compress the powdery/granular materials reliably in the main compression. In this respect the engagement means has a critical significance. That is, the engagement means allows the center punch and the outer punch in an engaged state to operate together as one unit with their respective punch tip end surfaces rendered flush with each other so as to conform to the outward shape of an aimed molded article.

To this end, the upper main compression roll should be configured so as not to press the center punch head part projecting from the outer punch head part; stated otherwise, the upper main compression roll should be configured to press the upper outer punch only. A roll configured to press only one side of the outer punch head part may be employed as the upper main compression roll of such a configuration. Advantageously, the upper main compression roll has a pressing surface with a groove to avoid pressing against the center punch head part projecting from the outer punch head part.

The rotary compression molding machine of the present invention may be configured such that slide restricting means is provided to restrict free movement of the upper center punch relative to the upper outer punch to allow one of the guide means to guide the upper center punch and the upper outer punch together unless any external force works on the upper center punch. Such a configuration makes it possible to simplify the guide means for the upper punch substantially.

An example of such slide restricting means comprises an O-ring and an annular groove to attach the O-ring. In this case, the O-ring is preferably made of an elastic material such as synthetic resin, synthetic rubber or natural rubber for example. Specifically, in the slide restricting means thus constructed, the annular groove is formed around the outer periphery of the upper center punch to attach the O-ring. In this construction the O-ring is brought into pressure contact with the inner wall of the upper outer punch and, hence, the upper center punch will not slide relative to the upper outer punch unless an external force exceeding the force pressing the O-ring against the upper outer punch is exerted on the upper center punch. As a result, the member to guide the upper center punch can be disposed only at a required but localized position, which enables the construction of the machine to be simplified. It is possible that such an O-ring is configured to fit on the outer punch side.

The O-ring employed as the above-mentioned slide restricting means can function as an oil seal. Further, when such an O-ring is used for the lower punch, the O-ring is able to inhibit inadvertent movement of the lower outer punch as well as to prevent powdery/granular material from entering a lower part of the lower punch and the associated guide rail.

The upper punch used in the rotary compression molding machine thus constructed is expressed as a double-structure punch for use in a rotary compression molding machine, which comprises: a center punch and an outer punch around the center punch, both of which are slidable and capable of pressing, the center punch having a head part configured to be capable of projecting from a head part of the outer punch; and engagement means for causing the center punch to engage the outer punch with the head part of the center punch in a state projecting maximally from the head part of the outer punch to allow both the punches to operate together as one unit.

In the upper punch of such a double structure the outer punch has a peripheral surface forming an opening and center punch positioning means projecting through the opening is provided, which is capable of guiding the center punch by external guide means. This arrangement makes the center punch easy to slide and guide.

The center punch of such a double-structure punch comprises a head part capable of projecting from a head part of the outer punch, an engaging part located adjacent to the head part of the center punch to engage the outer punch, and a projecting part formed at a peripheral surface of the center punch, the projecting part constituting positioning means capable of being guided by external guide means. There is no particular limitation on the structure and shape of the center punch positioning means as long as the positioning means is capable of being guided by external guide means. The positioning means may have a structure including a roller.

The engagement means for engaging the center punch and the outer punch with each other is the same as described earlier. Also as described earlier, the upper punch of the present invention may be provided with slide restricting means for restricting free movement of the upper center punch relative to the upper outer punch.

The respective sectional configurations of the punch tips of the center punch and the outer punch are determined from the respective shapes of the die bore, aimed molded article and core. Where the lower punch is also a double-structure punch, the sectional configuration of the punch tip of the lower punch is the same as that of the punch tip of the upper double-structure punch.

If the machine of the present invention is constructed to supply the second powdery/granular material or supply and mold the second powdery/granular material and then repeat a step completely the same as the step of supplying the second powdery/granular material or supplying and molding the second powdery/granular material, the machine can easily manufacture a molded article incorporating a row of cores that are continuous with each other vertically.

### BRIEF DESCRIPTION OF DRAWINGS

FIG. 1 is a sectional view illustrating a rotary compression molding machine as one embodiment of the present invention.

FIG. 2 is an exploded side elevational view illustrating movements of punches with operation of a rotary table according to the same embodiment.

FIG. 3 is an enlarged sectional view of a relevant part of the same embodiment for illustrating a state of the upper and lower punches at the time of filling of a first powdery/granular material.

FIG. 4 is an enlarged sectional view of a relevant part of the same embodiment for illustrating a state of the upper and lower punches at the time of first pre-compression.

FIG. 5 is an enlarged sectional view of a relevant part of the same embodiment for illustrating a state of the upper and lower punches at the time of filling of a second powdery/granular material after the first pre-compression.

FIG. 6 is an enlarged sectional view of a relevant part of the same embodiment for illustrating a state of the upper and lower punches at the time of second pre-compression.

FIG. 7 is an enlarged sectional view of a relevant part of the same embodiment for illustrating a state of the upper and lower punches at the time of filling of a third powdery/granular material after the second pre-compression.

FIG. 8 is an enlarged sectional view of a relevant part of the same embodiment for illustrating a state of the upper and lower punches at the time of main compression.

FIG. 9 is an enlarged sectional view of a relevant part of the same embodiment for illustrating a state of the upper and lower punches at the time of removing a molded article from a die bore.

FIG. 10 is an explanatory view illustrating the principle underlying the compression molding process according to the same embodiment.

FIG. 11 is an explanatory view illustrating the principle underlying the compression molding process according to another embodiment.

FIG. 12 is an enlarged sectional view of a relevant part of yet another embodiment for illustrating the structures of upper and lower punches.

FIG. 13 is an exploded side elevational view illustrating movements of the punches with operation of a rotary table according to the same embodiment.

FIG. 14 is an enlarged sectional view of a relevant part of the same embodiment for illustrating a state of the upper and lower punches at the time the respective punch tip end surfaces of an upper center punch and an upper outer punch are rendered flush with each other.

FIG. 15 is an enlarged sectional view of a relevant part of the same embodiment for illustrating a state of the upper and lower punches at the time of main compression.

FIG. 16 is a perspective view of the upper punch of the same embodiment with a lower part of an upper outer punch being partially cutaway for showing an O-ring structure constituting slide restricting means.

FIG. 17 is a cross-sectional view of a double-structured upper punch used in the same embodiment, taken at a part where a positioning member is present.

FIG. 18 is a perspective view showing one embodiment of an upper main compression roll for use in the present invention.

### BEST MODE FOR CARRYING OUT THE INVENTION

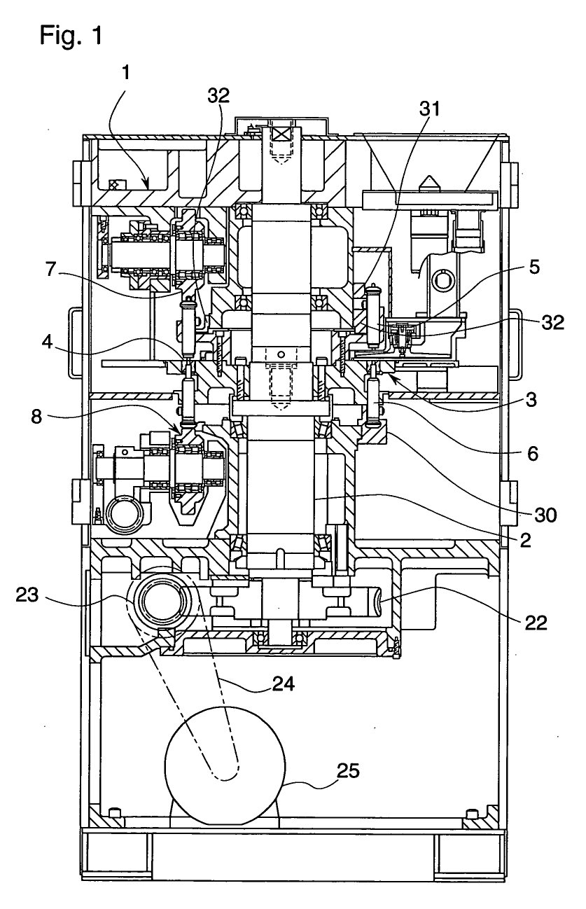

Hereinafter, one embodiment of the present invention will be described with reference to FIGS. 1 to 10 and 18.

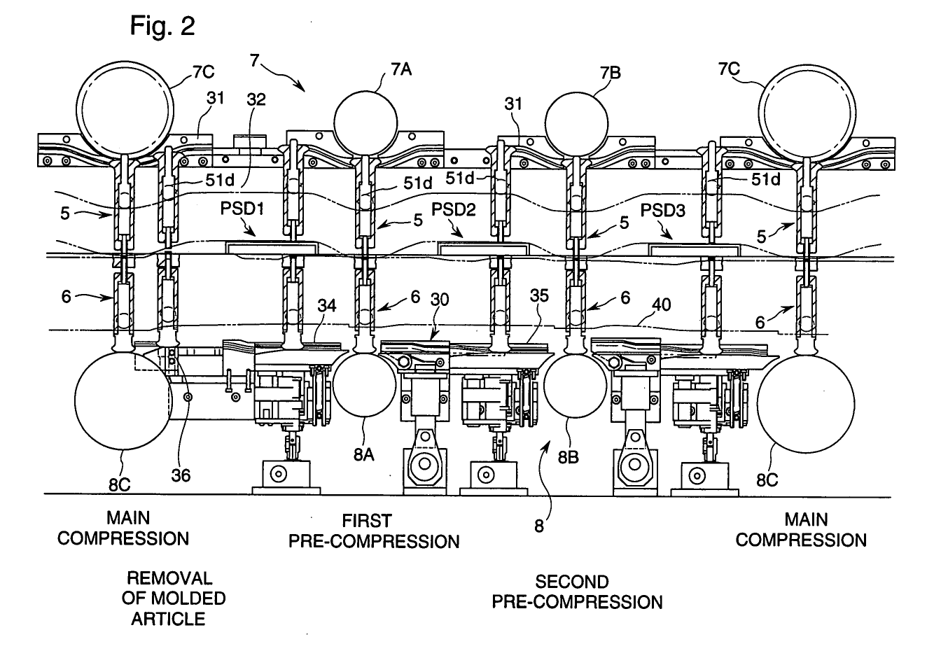

This rotary compression molding machine shown is adapted for compression molding of a core-incorporated molded article by feeding first, second and third powdery/granular materials PD1, PD2 and PD3 through first, second and third powdery/granular material feeding and filling sections PSD1, PSD2 and PSD3 (shown in FIG. 2). The rotary compression molding machine includes a rotary table 3 disposed in a frame 1 via a vertical shaft 2 for horizontal rotation, a plurality of dies 4, each of which has a die bore 4a, arranged circumferentially of the rotary table 3 at a predetermined pitch, and upper punch 5 and lower punch 6 vertically slidably held above and below each die 4. Pairs of upper roll 7 and lower roll 8 positioned above and below the rotary table 3 are arranged about the vertical shaft 2 so that a powdery/granular material filled in each die bore 4a is compression-molded by causing the upper and lower punches 5 and 6 with their respective tip ends, i.e. punch tips in a state inserted in the die bore 4a to pass through between upper rolls 7 and lower rolls 8 shown in FIG. 2 sequentially in a predetermined order, the upper rolls 7 consisting of an upper first pre-compression roll 7A, an upper second pre-compression roll 7B and an upper main compression roll 7C, the lower rolls 8, constituting lower compression means, consisting of a lower first pre-compression roll 8A, a lower second pre-compression roll 8B and a lower main compression roll 8C. As also shown in FIG. 18, the upper main compression roll 7C is formed with a groove 7Ca continuously extending circumferentially of the roll 7C and substantially centrally of an upper punch pressing surface of the roll 7C so as to avoid pressing against a head part 51a of an upper center punch 51 forming part of the upper punch 5 to be described later, the groove 7Ca having such width and depth as to receive the head part 51a of the upper center punch 51 without contact during main compression. In this way the upper main compression roll 7C presses against only a head part 52a of an upper outer punch 52. In this embodiment, unlike the upper main compression roll 7C, the first and second upper pre-compression rolls 7A and 7B are formed with ridges 7Aa and 7Ba, respectively, each of which has a width larger than the width of the head part 51a of the upper center punch 51 and continuously extends circumferentially of the relevant roll and substantially centrally of an upper punch pressing surface for easy pressing against only the head part 51a of the upper center punch 51.

The first, second and third powdery/granular material feeding and filling sections PSD1, PSD2 and PSD3 each comprise a combination of a hopper storing a powdery/granular material and a powdery/granular material feeding and filling device such as an open feed shoe or a mixing feed shoe for feeding the powdery/granular material fed from the hopper to the die bore 4a. As shown in FIG. 2, the first powdery/granular material feeding and filling section PSD1 is disposed at a location where the die 4 is positioned before reaching the location of the upper first pre-compression roll 7A and the lower first pre-compression roll 8A. Similarly, the second powdery/granular material feeding and filling section PSD2 is disposed at a location where the die 4 is positioned before reaching the location of the upper second pre-compression roll 7B and the lower second pre-compression roll 8B, and the third powdery/granular material feeding and filling section PSD3 is disposed at a location where the die 4 is positioned before reaching the location of the upper main compression roll 7C and the lower main compression roll 8C. It should be noted that since each of the first, second and third powdery/granular material feeding and filling sections PSD1, PSD2 and PSD3 can employ any powdery/granular feeding and filling device widely known in this field, only the location thereof is shown in FIG. 2.

The vertical shaft 2 rotates by rotation of a worm wheel 22 secured adjacent to the lower end of the vertical shaft 2. A worm 23 meshing with the worm wheel 22 transmits driving power of a main motor 25 to the worm wheel 22 through a V-belt 24.

Upper guide rails 31 and 32, which constitute guide means, mounted adjacent to the upper end of the vertical shaft 2 guide the upper punch 5 held at the rotary table 3 to its highest position at a location near the place where the powdery/granular material is filled and to a lower position just below the upper roll 7 when the upper punch 5 reaches the location of the upper roll 7. The upper punch 5 comprises upper center punch 51 which is independently slidable except when engaged for operation, and upper outer punch 52 circumscribing the upper center punch 51.

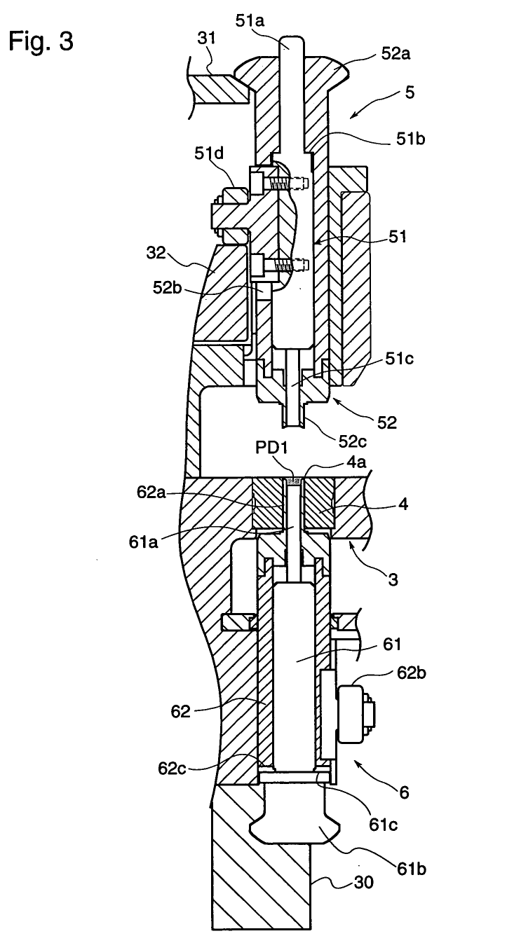

Specifically, as shown in FIGS. 3 to 9, the upper center punch 51 is shaped like coaxially-joined rods having different diameters, for example, and has head part 51a projecting from head part 52a of the upper outer punch 52 on the upper end side thereof, an engaging part 51b adjacent to the lower end of the head part 51a to engage the upper outer punch 52, and a punch tip 51a having an outer diameter substantially equal to that of a molded core product and located on the lower end side of the upper center punch 51. Further, the upper center punch 51 has a peripheral surface fitted with a rotatable center punch roller 51d as positioning means for positioning the punch tip of the upper center punch 51. The center punch roller 51d is fitted so as to project from an opening 52b formed at a peripheral surface of the upper outer punch 52.

On the other hand, the upper outer punch 52 circumscribing the upper center punch 51 is cylindrically shaped and has punch tip 52c having an outer diameter substantially equal to the inner diameter of the die bore 4a to allow the punch tip 51c of the upper center punch 51 to slide therewithin, the aforementioned opening 52b in a peripheral surface of a body part thereof, and an engaging part 52d to engage the engaging part 51b of the upper center punch 51. The engaging part 52d is positioned so that when the engaging part 52d is brought engagement with the engaging part 51b of the upper center punch 51, the head part 51a of the upper center punch 51 is allowed to project by a predetermined length while the respective punch tips 52c and 51c of the upper outer punch 52 and the upper center punch 51 are rendered flush with each other so as to conform to the outward shape of a molded article to be compression-molded.

The center punch roller 51d is adapted to be guided by a center punch guide rail 32 located above the rotary table 3 and inwardly from the upper punch 5. As shown in FIG. 2, the center punch guide rail 32 constituting the guide means guides the upper center punch 51 to its highest position when a powdery/granular material is filled into the die bore 4a or into lower outer punch tip 62a while failing to guide the upper center punch 51 when the upper center punch 51 is at a position for compressing the powdery/granular material with the upper and lower first pre-compression rolls 7A and 8A, the upper and lower second pre-compression rolls 7B and 8B or the upper and lower main compression rolls 7C and 8C. Since the upper center punch 51 has the engaging part 51b, the upper center punch 51 and the upper outer punch 52 are guided upwardly together as one unit by the center punch guide rail 32 when the engaging part 51b is in engagement with the engaging part 52d of the upper outer punch 52 and compresses the powdery/granular material at a time even when only the upper outer punch 52 is pressed during main compression with the upper and lower main compression rolls 7C and 8C.

In this embodiment, like the upper punch 5, the lower punch 6 has a double structure comprising a lower center punch 61 and a lower outer punch 62, both of which are independently slidable except when engaged together for operation, as shown in FIGS. 3 to 9. Specifically, the lower outer punch 62 of the lower punch 6 has a punch tip 62a having an outer diameter substantially equal to the inner diameter of the die bore 4a, and an outer punch roller 62b rotatably fitted to a peripheral surface of a cylindrical body part, the lower outer punch 62 accommodating the lower center punch 61 therein for sliding movement. On the other hand, the lower center punch 61 has a punch tip 61a having an outer diameter substantially equal to that of a molded core product, slidably accommodated in the punch tip 62a of the lower outer punch 62 and located on the upper end side of the lower center punch 61, a head part 61b for abutment with each lower roll 8, and an engaging part 61c located adjacent to the head part 61b to engage lower end 62c (corresponding to an engaging part of the outer punch) of the lower outer punch 62. The engagement means functions to cause the lower center punch 61 and the lower outer punch 62 to engage each other with the lower center punch 61 in a state retracted most deeply into the lower outer punch 62, thereby allowing both to operate as one unit.

The lower center punch 61 of the lower punch 6 is moved up and down by means of a lower guide rail 30 located below the rotary table 3. Specifically, as shown in FIG. 2, the lower guide rail 30 constituting guide means causes the lower center punch 61 to descend for pre-compression of the first powdery/granular material PD1 and subsequent pre-compression of the second powdery/granular material PD2 to fill the powdery/granular material into the lower outer punch tip 62a within the die bore 4a and thereafter ascend to a predetermined position by means of amount regulating rails 34 and 35 to regulate the amount of the powdery/granular material by eliminating excess powdery/granular material, and guides the lower center punch 61 to its highest position at a point past the lower main compression roll 8C when the molded article thus compression-molded is to be removed from the die bore 4a after completion of compression by the lower main compression roll 8c. In this case, by guiding of the lower center punch 61 to the highest position, the engaging part 61c of the lower center punch 61 becomes engaged with the lower end 62c of the lower outer punch 62 so that the lower center punch 61 and the lower outer punch 62 move as one unit to push the molded article thus formed out of the die bore 4a. The outer punch roller 62b is adapted to be guided by outer punch guide rail 40 constituting guide means located below the rotary table 3. The outer punch guide rail 40 guides the lower outer punch 62 so that its punch tip is positioned substantially to be matched with the upper end of the die 4 until the lower outer punch 62 has passed through between the upper and lower pre-compression rolls 7A, 7B, 8A and 8B. Thus, the punch tip of the lower outer punch 62 resides within the die bore 4a to function as part of the die bore temporarily. In contrast, until the lower outer punch 62 has passed through between the upper and lower main compression rolls 7C and 8C after the upper and lower pre-compression rolls 7A, 7B, 8A and 8B, the vertical position of the lower outer punch 62 is changed to become coincident with the position of the lower center punch 61 guided by the lower guide rail 30; that is, the vertical position of the lower outer punch 62 is changed so that the respective tip end surfaces of the punch tip 61a of the lower center punch 61 and the punch tip 62a of the lower outer punch 62 become flush with each other. In this state, the engaging part 61c of the lower center punch 61 and the lower end 62c of the lower outer punch 62 are in engagement with each other and, hence, the lower center punch 61 and the lower outer punch 62 are operable at a time as one unit to compress the powdery/granular material within the die bore 4a.

In manufacturing a core-incorporated molded article with the rotary compression molding machine thus constructed, the lower center punch 61 is guided downwardly by the lower guide rail 30 as shown in FIG. 2, so that the first powdery/granular material PD1 that will form an outer layer of the aimed molded article is filled into the lower outer punch tip 62a within the die bore 4a through the first powdery/granular material feeding and filling section PSD1. At this time, the outer punch roller 62b of the lower outer punch 62 is guided along the outer punch guide rail 40 so that the upper end of the punch tip 62a thereof is held at a position substantially coinciding with the upper surface of the die 4. On the other hand, since the upper center punch 51 of the upper punch 5 is guided to its highest position by the center punch guide rail 32, the engaging part 51b of the upper center punch 51 is brought into engagement with the engaging part 52d of the upper outer punch 52, so that the upper center punch 51 and the upper outer punch 52 are held as one unit at that position (see FIG. 3). Thus, the upper center punch 51 does not project from the punch tip 52c of the upper outer punch 52, which is preferable because nothing interferes with the filling of the first powdery/granular material PD1.

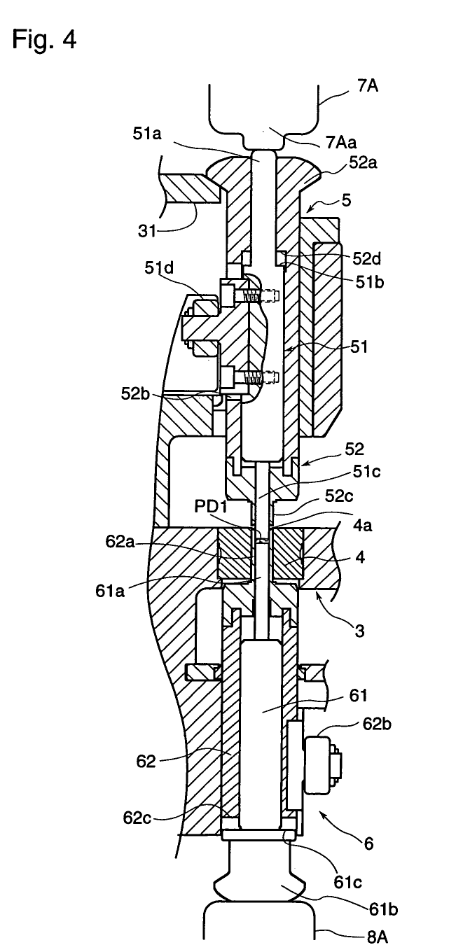

Subsequently, the rotary table 3 rotates, and the upper center punch 51 and lower center punch 61 inserted in the lower outer punch tip 62a within the die bore 4a filled with the first powdery/granular material PD1 are pressed by the upper and lower first pre-compression rolls 7A and 8A, respectively (FIG. 4). In this case, the punch tip 52c of the upper outer punch 52 is held spaced upwardly from the upper surface of the rotary table 3. Since the head part 51a of the upper center punch 51 projecting from the head part 52a of the upper outer punch 52 is pressed by the upper first pre-compression roll 7A, only the punch tip 51c of the upper center punch 51 is inserted into the lower outer punch tip 62a within the die bore 4a to compress the first powdery/granular material PD1 (first pre-compression). In this way, an outer layer part located under the mass forming the molded core product part is pre-compressed.

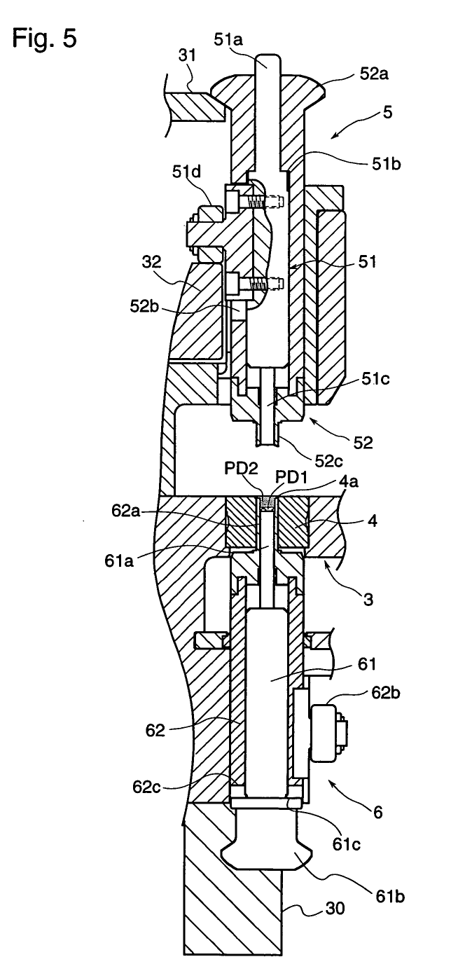

After the compression of the first powdery/granular material PD1, the second powdery/granular material PD2, which will be compressed to become the molded core product, is filled into the lower outer punch tip 62a by means of the second powdery/granular material feeding and filling section PSD2, with the lower center punch 61 being held adjacent to its position for the first pre-compression (FIG. 5). In the filling of the second powdery/granular material PD2, as in the filling of the first powdery/granular material PD1, the upper center punch 51 guided by the center punch guide rail 32 is held at its highest position.

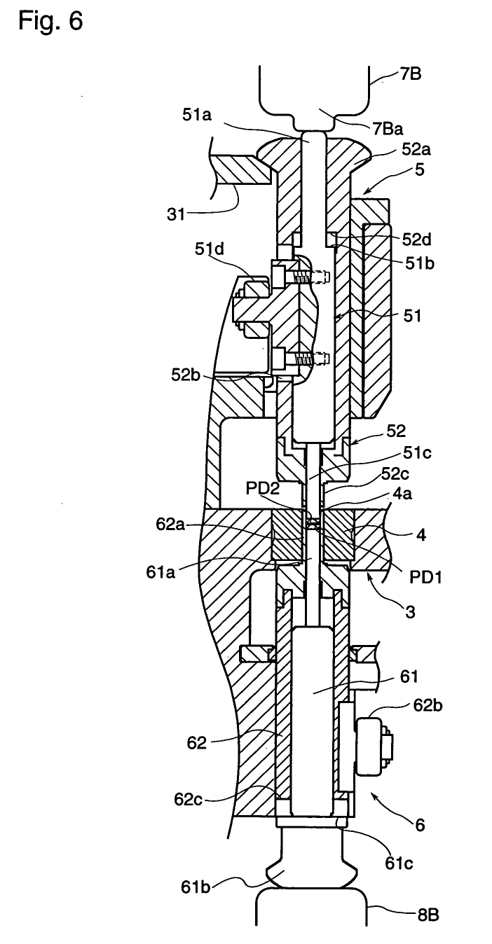

After the filling of the second powdery/granular material PD2, the rotary table 3 rotates and the upper and lower second pre-compression rolls 7B and 8B press the upper and lower center punches 51 and 61, respectively (FIG. 6). In this case, the respective positions of the upper and lower punches 5 and 6 are held as in the case where the upper and lower center punches 51 and 61 pass the upper and lower first pre-compression rolls 7A and 8A. In this way, the mass comprising the second powdery/granular material PD2 that will form the molded core product is pre-compressed (second pre-compression).

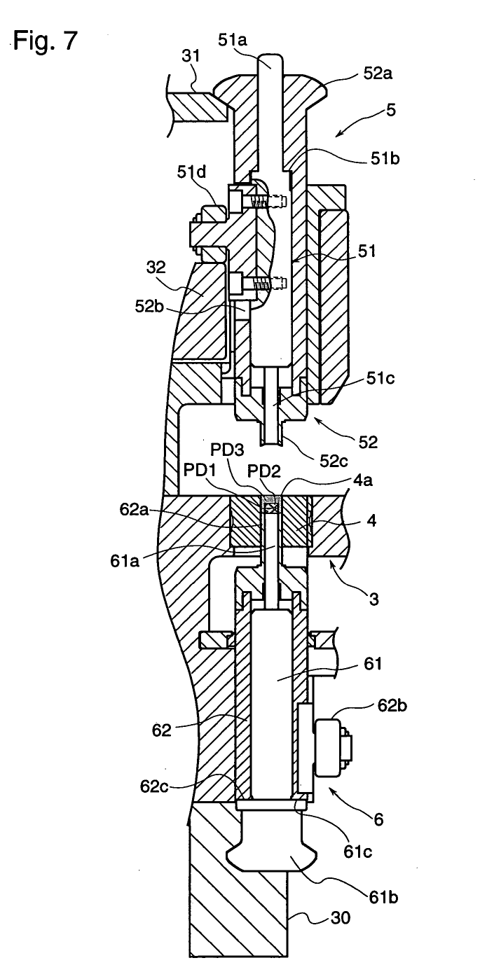

After completion of the second pre-compression by the upper and lower second pre-compression rolls 7B and 8B, the center punch roller 51d of the upper punch 5 is held at its highest position by the center punch guide rail 32 (FIG. 7). At this time, the outer punch guide rail 40 guides the outer punch roller 62b of the lower outer punch 62 down to a position to cause the lower end 62c thereof to engage the engaging part 61c of the lower center punch 61, whereby the respective tip end surfaces of the punch tip 62a and the punch tip 61a of the lower center punch 61 become flush with each other. When the lower outer punch 62 descends here, the molded product resulting from the second pre-compression, which comprises two layers of the first powdery/granular material PD1 and the second powdery/granular material PD2, is supported by the lower center punch 61, or, namely, rests on the punch tip 61a of the lower center punch 61. Then, with the respective tip end surfaces of the punch tips 62a and 61a of the lower outer punch 62 and the lower center punch 61 in a state rendered flush with each other, the third powdery/granular material PD3 that will form an outer layer is filled into the die bore 4a through the third powdery/granular material feeding and filling section PSD3. The third powdery/granular material PD3 thus filled is deposited on the side and top of the aforementioned molded product comprising two layers. Here, it is possible to fill the third powdery/granular material PD3 while lowering the lower outer punch 62.

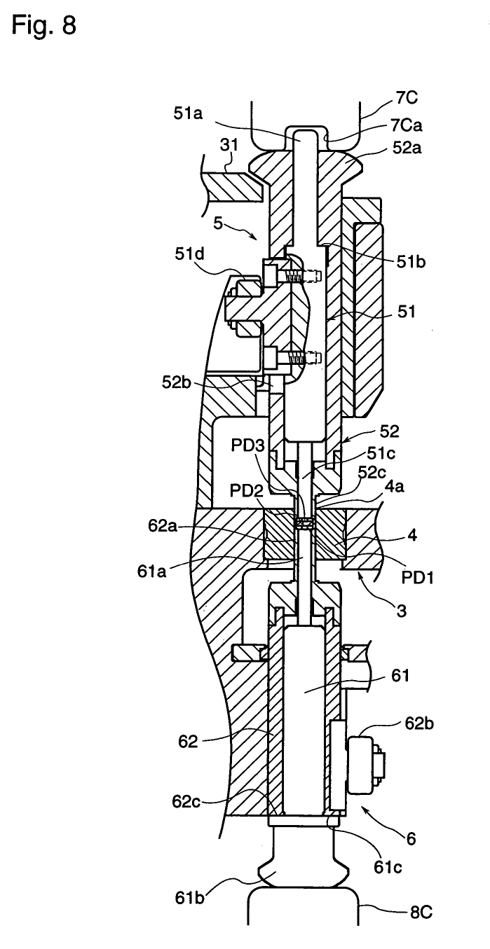

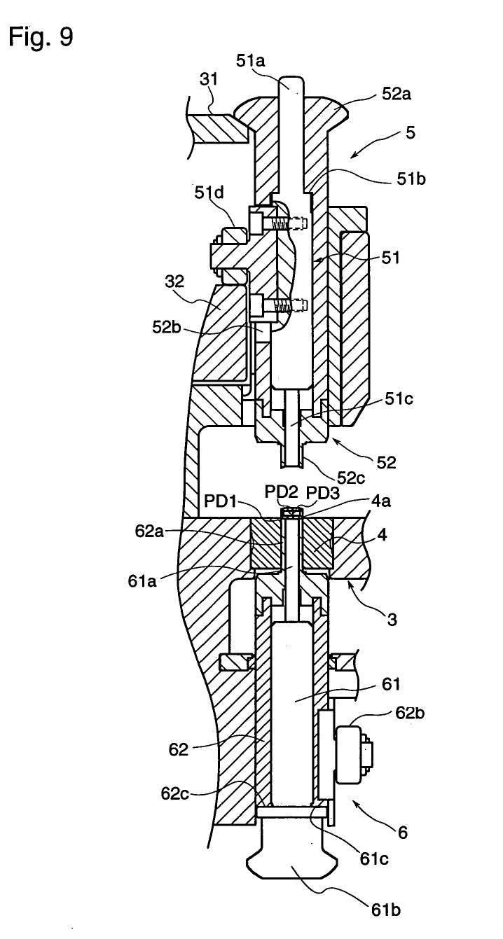

After completion of the filling of the third powdery/granular material PD3, the rotary table 3 rotates to start the main compression process (FIG. 8). When the upper center punch 51 is positioned at the location of the upper and lower main compression rolls 7C and 8C, the center punch roller 51d thereof assumes a condition failing to be guided by the center punch guide rail 32. When the upper outer punch 52 is pressed by the upper main compression roll 7C, the engaging part 52d of the upper outer punch 52 engages the engaging part 51b of the upper center punch 61. In this way the respective tip end parts of the upper outer punch 52 and the upper center punch 51 become flush with each other. Though the head part 51a of the upper center punch 51 projects from the head part 52a of the upper outer punch 52, the pressing force of the upper main compression roll 7C does not directly work on the upper center punch 51 by virtue of the groove 7Ca defined in the upper main compression roll 7C. Specifically, the pressing force of the upper main compression roll 7C works on the upper outer punch 52 which is operable together with the upper center punch 51 as one unit when the engaging part 52d and the engaging part 51b are brought into engagement with each other, hence, works on the upper center punch 51 via the upper outer punch 52. On the other hand, the lower punch 6 in a state held at the same height as in the filling of the third powdery/granular material PD3 is pressed by the lower main compression roll 8C. Specifically, the lower outer punch 62 is operable together with the lower center punch 61 as one unit when the lower end 62c of the lower outer punch 62 engages the engaging part 61c of the lower center punch 61. After completion of the main compression, the lower punch 6 is guided by the lower guide rail 30 to a height at which the respective tip end parts of the punch tips 61a and 62a thereof become substantially coinciding with the upper surface of the rotary table 3, thereby removing the resulting core-incorporated molded article from the die bore 4a (FIG. 9).

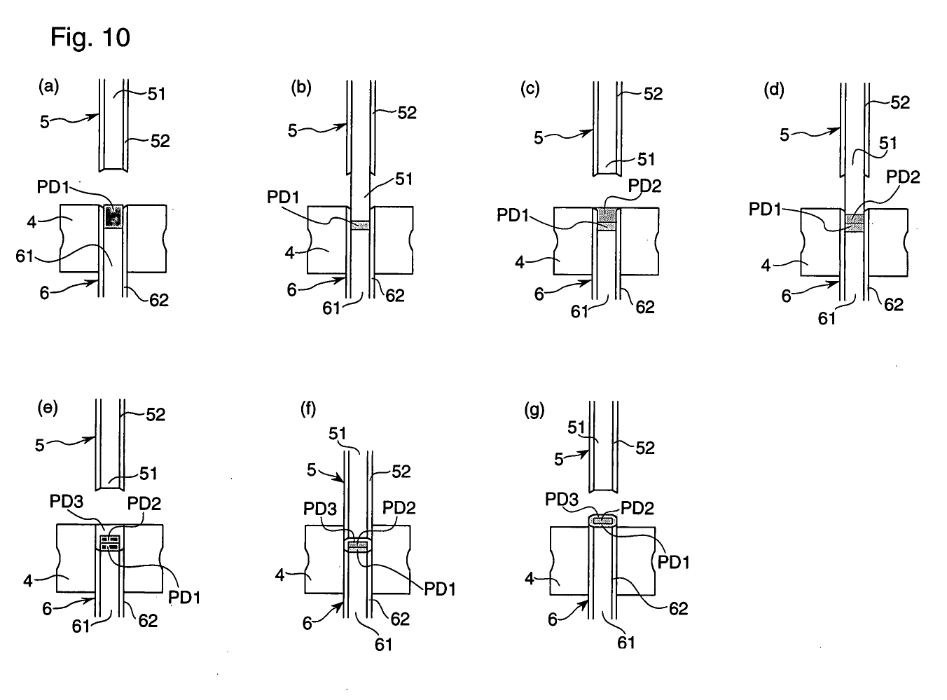

FIG. 10 collectively illustrates the flow of the manufacturing process for a core-incorporated molded article. In FIG. 10, (a) corresponds to the process step shown in FIG. 3 and, likewise, (b), (c), (d), (e), (f) and (g) correspond to the process steps shown in FIGS. 4, 5, 6, 7, 8 and 9, respectively.

According to this embodiment, main compression is achieved not by using separate compression means for pressing the center punch and the outer punch but by operating the upper center punch 51 and the upper outer punch 52 as one unit as well as the lower center punch 61 and the lower outer punch 62 as one unit. Thus, the main compression can be achieved with a pair of upper and lower rolls, which makes it possible to simplify the mechanism associated with the main compression. Further, like a single continuous punch not divided into upper punch 5 and lower punch 6, the punch tips of the upper and lower punches 5 and 6 can compression-mold a powdery/granular material in the die bore 4a reliably. Since the respective tip end parts of the punch tips 51c and 52c, as well as the respective tip end parts of the punch tips 61a and 62a, of the center punches and the outer punches are rendered flush with each other so as to conform to the outward shape of an aimed molded article in the compression molding, the occurrence of a problem such as formation of a stepped part on the surface of a molded article can reliably be obviated.

In the foregoing embodiment, the first pre-compression step shown in FIG. 10(b) may be eliminated. Specifically, after the filling of the first powdery/granular material PD1, the lower center punch 61 is caused to descend so as to allow a predetermined amount of the second powdery/granular material PD2 which will form a molded core to be filled and then the predetermined amount of the second powdery/granular material PD2 is filled on the upper side of the mass of the first powdery/granular material PD1 in the punch tip 62a of the lower outer punch 62. In this state, the upper center punch 51 is actuated to pre-compress the first and second powdery/granular materials PD1 and PD2 at a time. In this case, it is preferable to press down the surface of the mass of the first powdery/granular material PD1 with the upper center punch 51 or take other measure after the filling of the first powdery/granular material PD1.

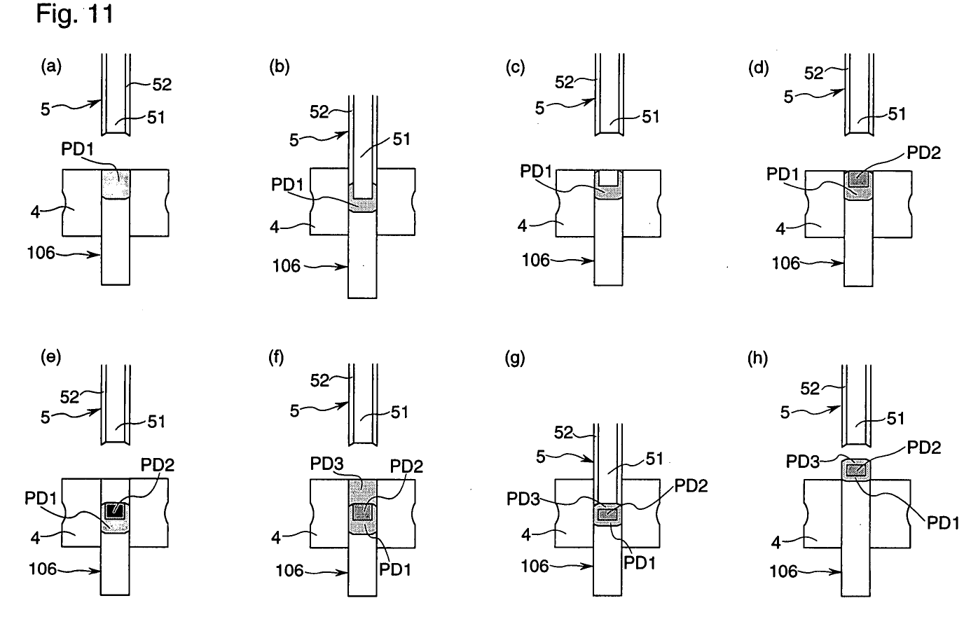

While the foregoing embodiment uses the lower punch having a double structure comprising the lower center punch 61 and the lower outer punch 62, a lower punch 106 which does not have a double structure may be used. With the lower punch 106 having such a feature, a core-incorporated molded article can be molded according to the following process shown in FIG. 11.

(1) The lower punch is caused to descend in accordance with the size of a molded article to be formed and the first powdery/granular material PD1 which will form an outer layer is filled into the die bore 4a (FIG. 11(a)).

(2) After the filling of the first powdery/granular material PD1, pre-compression is performed with the upper center punch 51 in a state projecting from the upper outer punch 52. This step molds the first powdery/granular material PD1 thus filled into a provisional cup form within the die bore 4a while forming a space to be filled with the second powdery/granular material PD2 which will form a core in the resulting molded product of the first powdery/granular material PD1 which will form the outer layer (FIG. 11(b)). In this pre-compression, the upper center punch having an engaging part constituted of a peripheral edge part, situated on the punch tip side, of the body (trunk) part of the upper center punch, i.e., a boundary part between the body part and the punch tip 51c, is brought into engagement with an inner peripheral edge part, situated on the punch tip side, of the body (trunk) part of the upper outer punch.

(3) After completion of the pre-compression of the first powdery/granular material PD1, the lower punch 106 is caused to ascend so that the upper surface of the provisional molded product coincides with the upper surface of the die 4 (FIG. 11(c)). Subsequently, the second powdery/granular material PD2 is filled into the cup-shaped space formed by the pre-compression (FIG. 11(d)).

(4) After completion of the filling of the second powdery/granular material PD2, the second powdery/granular material PD2 is preferably pre-compressed with the upper center punch 51 and the lower punch 106, and then the lower punch 106 is caused to descend (FIG. 11(e)), followed by filling of the third powdery/granular material PD3 to form an upper outer layer of the aimed core-incorporated molded article (FIG. 11(f)).

(5) After completion of the filling of the third powdery/granular material PD3, main compression is performed with the upper punch 5 in a state where the respective tip end surfaces of the upper center punch 51 and the upper outer punch 52 are rendered flush with each other (FIG. 11(g)). Thereafter, the lower punch 106 is caused to ascend to allow the resulting core-incorporated molded article to be removed from the die bore 4a (FIG. 11(h)).

In this embodiment, the lower punch 106, which is of the conventional structure different from a double structure, is used to mold a core-incorporated molded article from two kinds of powdery/granular material without preparing a molded product that will form the core in advance. This feature makes it possible to simplify the construction of the machine as well as to make the molding of a core-incorporated molded article efficient. It should be noted that this method using a conventional punch as the lower punch has some difficulty in uniform filling of powdery/granular material at the step of molding the filled first powdery/granular material PD1 into a cup form and, therefore, it is preferable to use a lower punch having a double structure like the upper punch.

In the embodiment having been described first, the upper center punch 51 and the upper outer punch 52, which constitute the upper punch 5, are configured so as to ascend and descend basically independently by being guided by respective separate guide rails, and similarly, the lower center punch 61 and the lower outer punch 62, which constitute the lower punch 6, are configured so as to ascend and descend by being guided by respective separate guide rails. In the following embodiment, upper center punch 251 of upper punch 205, which is configured to ascend and descend without being guided by a guide rail, will be described. Specifically, the upper center punch 251 used in this embodiment is configured to ascend and descend together with upper outer punch 252 of the upper punch 205 usually and to be stopped by position changing member 207 at the timing when guided movement is necessary. When the upper center punch 251 is stopped, the upper outer punch 252 is downwardly guided by upper guide rail 31 with the result that the upper center punch 251 ascends relative to the upper outer punch 252.

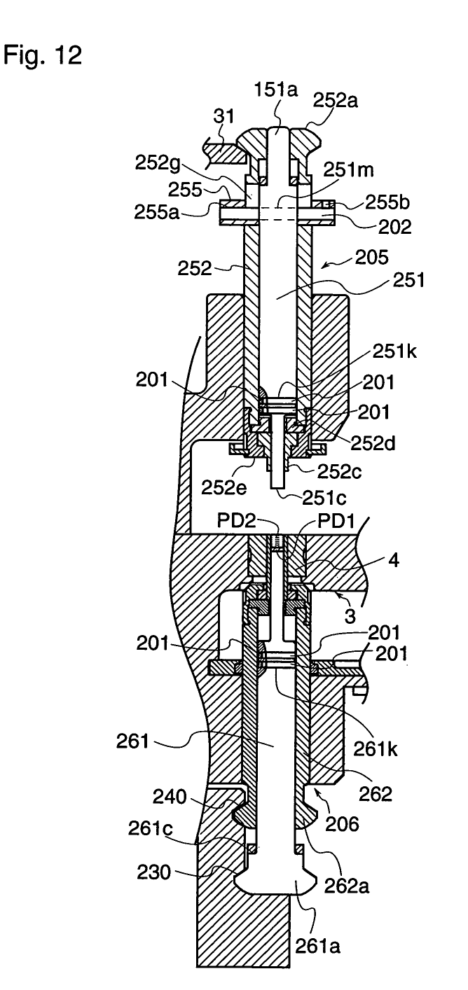

As shown in FIG. 12, the upper punch 205 according to this embodiment is provided with an annular positioning member 255 on the upper end side of the upper center punch 251 as a substitute for the center punch roller 51d of the foregoing embodiment, and slide restricting means comprising an annular groove 251k and an O-ring 201 fitted therein, which are located on the lower end side of the upper center punch 251. Further, the tip end part of the upper outer punch 252 including the punch tip comprises a plurality of members to allow punch tip member 252c to be replaced when the degree of wear thereof requires replacement. FIG. 12 illustrates a state of this embodiment in which the second powdery/granular material PD2 is filled in the lower outer punch tip after the first pre-compression.

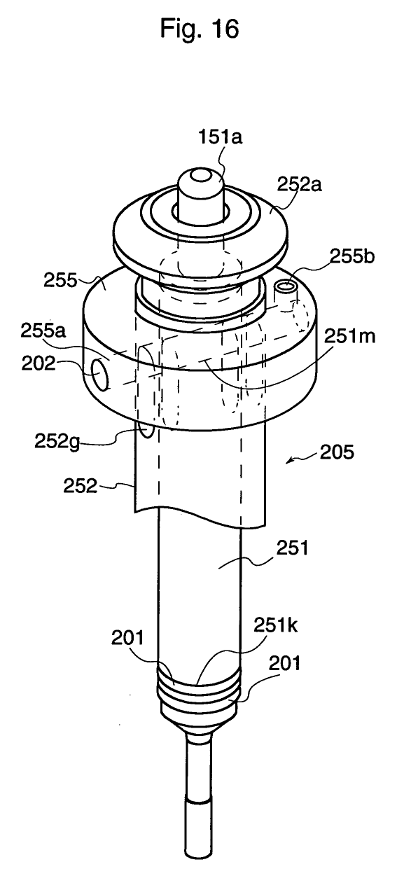

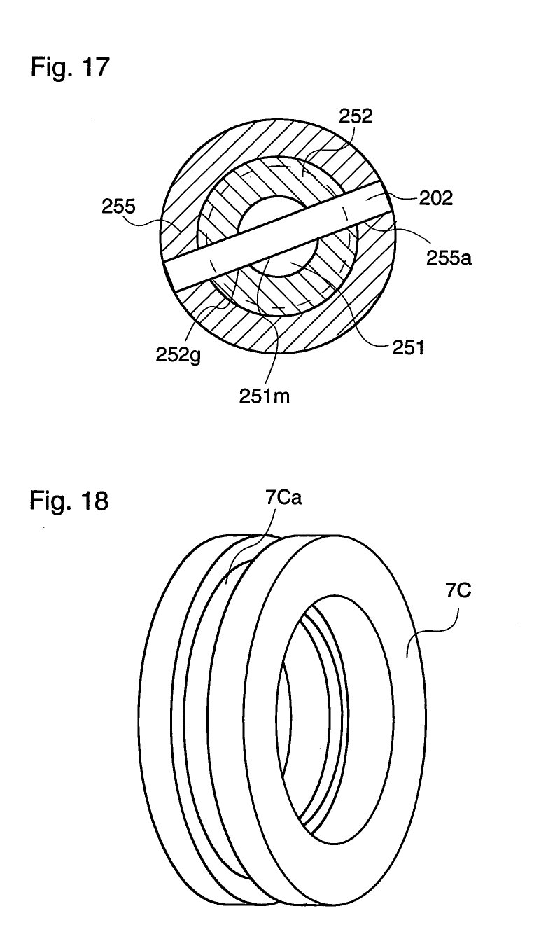

The positioning member 255 specifically shown in FIGS. 16 and 17 preferably has an inner diameter substantially equal to the outer diameter of the body part of the upper outer punch 252 to prevent rattling. The positioning member 255 has a through-hole 255a diametrically extending through the peripheral wall thereof. The positioning member 255 is fitted on the upper center punch 251 by aligning the through-hole 255a with a through-hole 251m of the upper center punch 251 formed at a predetermined location on the upper end side of the upper center punch 251 and then inserting an insert axis 202 through the through-holes 251m and 255a. The insert axis 202 is fixed with a setscrew 255b threadingly fitted in the positioning member 255 so as not to come off. The positioning member 255 having such an annular shape can be guided under the same condition at any part thereof by the position changing member 207 even when the upper punch rotates around its axis during the operation of the machine.

As also shown in the lower half of FIG. 16, the O-ring 201 serving as the slide restricting means is fitted in each of axially parallel two annular grooves 251k located adjacent the tip end part of the upper center punch 251. The O-ring 201 is made from materials having resilience (resilient material) such as synthetic resin, synthetic rubber or natural rubber. The O-ring 201 serves also as an oil seal. Specifically, each of the annular grooves 251k is sized to have a bottom diameter substantially equal to the inner diameter of the O-ring 201 and a depth slightly smaller than the thickness of the O-ring 201. Accordingly, the outer diameter of the O-ring 201 is slightly larger than the outer diameter of the body part of the upper center punch 251. Thus, when the O-ring 201 is fitted in each annular groove 251k, the outer diameter thereof becomes slightly larger than the inner diameter of the outer punch.

When the upper center punch 251 fitted with the O-rings 201 is inserted into the upper outer punch 252, the O-rings 201 press against the inner wall of the upper outer punch 252, thereby restricting sliding of the upper center punch 251. As a result, the upper center punch 251 ascends and descends together with the upper outer punch 252 as one unit unless any external force is exerted on the upper center punch 251. At the same time, due to the O-rings 201 intimately contacting the inner wall of the upper outer punch 252, lubricating oil present between the upper center punch 251 and the upper outer punch 252 is restrained from moving toward the punch tip. In this way, the O-rings 201 also function as an oil seal. In this embodiment the lower punch also employs a similar structure as will be described later.

In contrast to the upper center punch 251 thus described, the upper outer punch 252 supporting the upper center punch 251 for sliding movement is constructed as follows. The upper outer punch 252 provides at a predetermined location on the upper end side thereof an elliptical opening 252g through which the insert axis 202 of the positioning member 255 is inserted for fitting the positioning member 255 to the upper center punch 251. The elliptical opening 252g is elongated vertically of the upper outer punch 252 and has a length corresponding to the stroke of the upper center punch 251. In the upper outer punch 252, the punch tip member 252c is removably fitted to the tip end part of the upper outer punch 252 so as to facilitate replacement of the punch tip when worn. Specifically, the tip end part of the upper outer punch 252 comprises three members: cylindrical punch tip member 252c into which punch tip 251c of the upper center punch 251 is inserted, punch tip setting member 252d setting the punch tip member 252c, and flanged punch tip fixture member 252e fitting the punch tip member 252c set by the punch tip setting member 252d to the body part. Though the punch tip of the upper center punch 251 is molded integrally with the body (trunk) part in this embodiment, the punch tip may be a member separate from the body part as in the upper outer punch 252 as the need arises, and only the punch tip part may be rendered replaceable by constructing only the punch tip part as a single member to be attached to the body (trunk) part. This can be applied to the lower center punch 261.

Like the upper outer punch 252 of the upper punch 205, the lower punch 206 has the tip end part comprising a plurality of members and, hence, only the punch tip part is replaceable. The lower center punch 261 has annular grooves 261k and O-rings 201 constituting slide restricting means similar to that of the upper center punch 251, thereby inhibiting an inadvertent movement of the lower outer punch 262 in the compression process while preventing powdery/granular material from entering the lower part of the lower punch 206, the lower center punch guide rail 230 or the lower outer punch guide rail 240. Further, the lower punch 206 is formed at the lower end of the lower outer punch 262 with head part 262a having substantially the same shape as head part 261a of the lower center punch 261 as a substitute for the lower outer punch roller 62b of the foregoing embodiment. The lower outer punch 262 is configured to slide up and down independently of the lower center punch 261 as the head part 262a is guided along the lower outer punch guide rail 240. Similarly, the lower center punch 261 is configured to ascend and descend as the head part 261a thereof is guided along the lower center punch guide rail 230.

Additionally, the lower punch 206 has a structure that the head part 261a of the lower center punch 261 projects from the head part 262a of the lower outer punch 262, and the head part 261a of the lower center punch 261 is formed on the upper side thereof with engaging part 261c to engage the head part 262a of the lower outer punch 262 when the lower center punch 261 and the lower outer punch 262 operate with their respective punch tip end surfaces rendered flush with each other.

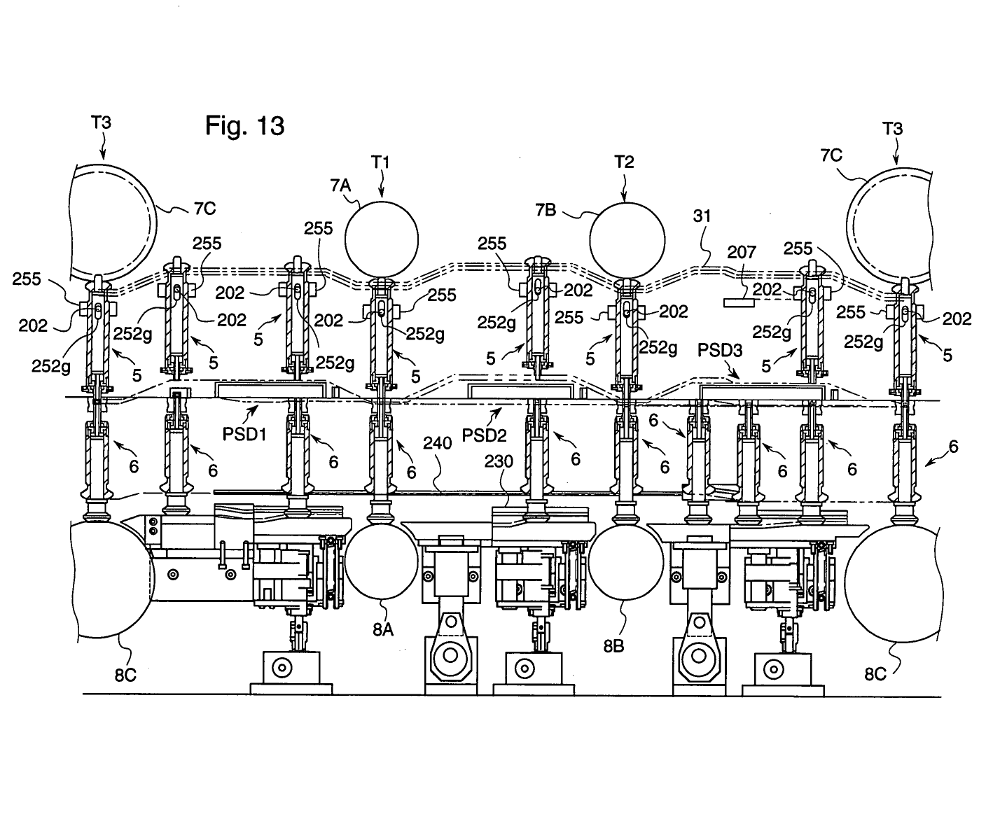

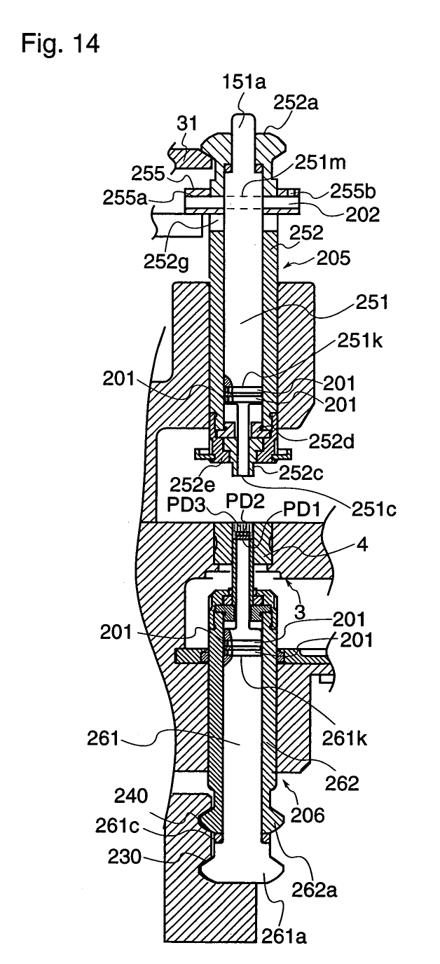

The position changing member 207 to guide the upper center punch 251 of the upper punch 205 does not need to extend continuously around the vertical shaft 3 as does the upper center guide rail 32 of the foregoing embodiment but is localized not continuously between the second pre-compression step and the main compression step as shown in FIG. 13. Specifically, the position changing member 207 is located below the upper guide rail 31 between the upper second pre-compression roll 7B and the upper main compression roll 7C. Accordingly, the position changing member 207 does not guide the upper center punch 251 constantly during the operation of the machine but functions to restrain the upper center punch 251 from descending following the upper outer punch 252 at the timing when the third powdery/granular material is to be filled into the die bore 4a after the completion of the second pre-compression step.

In the above-described construction, the upper punch 205 and the lower punch 206 are caused to ascend and descend basically in the same manner as in the foregoing embodiment. As to the movements of the upper punch 205 and the lower punch 206, since the upper center punch 251 fails to descend due to the O-rings 201 unless any external force is exerted thereon, the upper punch 205 ascends and descends as the upper outer punch 252 is guided along the upper guide rail 31. As shown in FIG. 13, the upper punch 205 moves with the punch tip 251c of the upper center punch 251 in a state projecting from the tip end of the punch tip member 252c of the upper outer punch 252 (shown in FIG. 12) over the distance from a point past the first pre-compression (T1), through the second pre-compression (T2), to a substantially midpoint between the second pre-compression and the main compression (T3). Thus, the upper center punch 251 and the upper outer punch 252 of the upper punch 205 ascend and descend together as one unit except when the position changing member 207 functions.

At the timing before the powdery/granular material in the die bore 4a is subjected to main compression, that is, at substantially the midpoint between the second pre-compression and the main compression, the upper outer punch 252 is caused to descend, while the upper center punch 251 is kept stationary by bringing the positioning member 255 fitted to the upper center punch 251 into engagement with the position changing member 207. Here, the upper outer punch 252 is caused to descend by means of the upper guide rail 31 and a non-illustrated up-and-down cam. Thus, the punch tip 251c of the upper center punch 251 relatively moves into the punch tip member 252 forming the punch tip of the upper outer punch 252. Finally, with the upper center punch 251 and the upper outer punch 252 in a state engaged with each other by the aforementioned engagement means of the upper center punch 251 and upper outer punch 252, the respective punch tip end surfaces of the upper center punch 251 and the upper outer punch 252 are rendered flush with each other so as to conform to the outward shape of the aimed molded article. The position changing member 207 may be configured to fix the upper outer punch with the upper guide rail 31 thereby guiding the upper center punch upwardly or may be configured otherwise.

In cooperation therewith, the lower center punch 261 and the lower outer punch 262 are kept at their most lowered positions corresponding to the state where the punch tip 251c of the upper center punch 251 is retracted into the punch tip 252c of the upper outer punch 252; that is, the respective punch tip end surfaces of the lower center punch 261 and the lower outer punch 262 are kept flush with each other. In this state, the engaging part 261c of the lower center punch 261 is brought into engagement the head part 262a of the lower outer punch 262 and, hence, the lower center punch 261 and the lower outer punch 262 operate together as one unit.

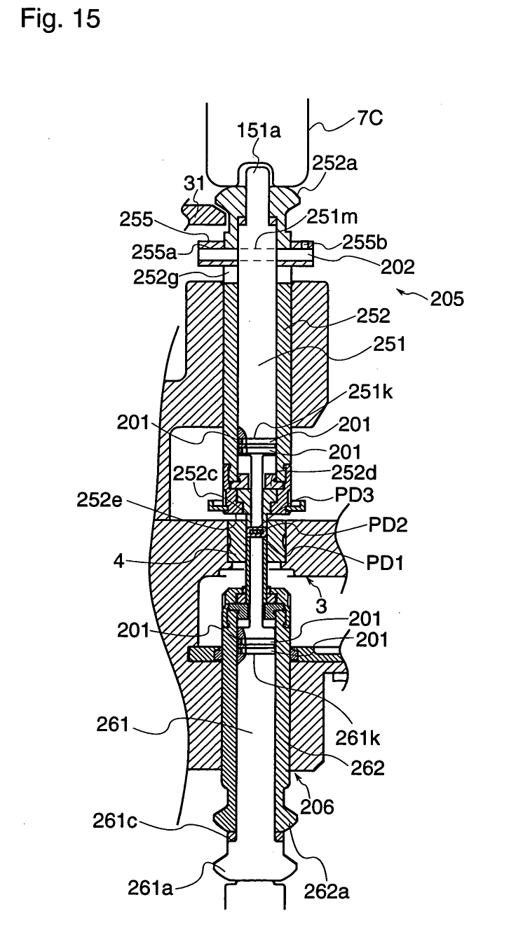

Thereafter, during the passage from a point past the position changing member 207 to a point past the upper and lower main compression rolls 7c and 8C, the O-rings 201 inhibit descent of the upper center punch 251. Therefore, the upper center punch 251 reaches the upper main compression roll 7C while projecting the head part 251a thereof from the head part 252a of the upper outer punch 252 (FIG. 15). On the other hand, the lower punch 206 is guided to the lower main compression roll 8C by the lower center punch guide rail 230 and the lower outer punch guide rail 240.

Thus, the O-rings 201 fitted on the upper center punch 251 restrict relative movement between the upper center punch 251 and the upper outer punch 252, so that the upper center punch 251 ascends and descends together with the upper outer punch 252 as one unit unless any external force is exerted thereon. This embodiment thus constructed does not require a continuous guide rail to cause the upper center punch 251 to ascend and descend and hence makes it possible to simplify the machine and lower the required parts count.

The present invention is not limited to the foregoing embodiments described above. The construction of each part is not limited to the illustrated examples and may be variously modified without departing from the concept of the present invention.

### INDUSTRIAL APPLICABILITY

The present invention is capable of manufacturing a core-incorporated molded article without the need to feed a molded-state part that will form a core and hence is useful as a molded article manufacturing apparatus in the industry of pharmaceuticals, foods or the like.

1. A rotary compression molding machine wherein: a rotary table is rotatably disposed in a frame; dies each having a die bore are mounted to the rotary table at a predetermined pitch; an upper punch and a lower punch are vertically slidably held above and below each of the dies; and a powdery/granular material filled in the die bore is compression-molded when respective punch tips of the upper and lower punches in a state inserted in the die bore pass through between an upper roll and a lower roll,
the rotary compression molding machine being characterized in that at least the upper punch comprises a center punch and an outer punch around the center punch, both of which are slidable and capable of pressing, the upper center punch having a head part capable of projecting from a head part of the upper outer punch, and characterized by comprising:
a plurality of powdery/granular material feeding and filling sections;
guide means for guiding the center punch and the outer punch either separately or as one unit;
an upper pre-compression roll operative to press the center punch or both of the center punch and the outer punch guided by the guide means;
lower pre-compression means making a pair with the upper pre-compression roll;
engagement means for causing the upper center punch to engage the upper outer punch with the head part of the upper center punch in a state projecting maximally from the head part of the upper outer punch to allow the upper center punch and the upper outer punch to operate together as one unit;
an upper main compression roll operative to press the upper center punch and the upper outer punch turned into one unit by engagement therebetween caused by the engagement means; and
lower main compression means making a pair with the upper main compression roll.

2. The rotary compression molding machine in accordance with claim 1, wherein:
the powdery/granular material feeding and filling sections include a first powdery/granular material feeding and filling section for feeding a first powdery/granular material, a second powdery/granular material feeding and filling section for feeding a second powdery/granular material, and a third powdery/granular material feeding and filling section for feeding a third powdery/granular material;
the upper pre-compression roll is operative to press the center punch or both the center punch and the outer punch guided by the guide means to compress the first powdery/granular material and/or the second powdery/granular material filled in the die bore;
the upper main compression roll is operative to press the upper center punch and the upper outer punch turned into one unit by engagement therebetween caused by the engagement means with the die bore in a state filled with the third powdery/granular material after completion of the compressing operation by the pre-compression rolls; and
the lower pre-compression means and the lower main compression means each comprises a compression roll.

3. The rotary compression molding machine in accordance with claim 2, wherein: the pre-compression rolls include two pairs of pre-compression rolls consisting of a pair of pre-compression rolls for compressing the first powdery/granular material and a pair of pre-compression rolls for compressing the second powdery/granular material.

4. The rotary compression molding machine in accordance with claim 2, wherein the lower punch comprises a center punch and an outer punch around the center punch, both of which are slidable and capable of pressing.

5. The rotary compression molding machine in accordance with claim 4, wherein: the lower center punch has a head part configured to be capable of projecting from a lower end of the lower outer punch; engagement means is provided for causing the lower center punch in a state retracted most deeply into the lower outer punch to engage the lower outer punch to allow the lower center punch and the lower outer punch to operate together as one unit; the lower pre-compression roll is operative to press only the lower center punch in a state of not engaged with the lower outer punch; and the lower main compression roll is operative to press simultaneously the lower center punch and the lower outer punch in a state engaged with each other by the engagement means.

6. The rotary compression molding machine in accordance with claim 2 or 5, wherein the engagement means comprises a center punch engaging part located adjacent to a center punch head part for engaging an outer punch, and an outer punch engaging part located at the outer punch for engaging the engaging part of the center punch.

7. The rotary compression molding machine in accordance with any one of claims 2 to 4, wherein: the upper main compression roll has a pressing surface with a groove to avoid pressing against the center punch head part projecting from the outer punch head part.

8. The rotary compression molding machine in accordance with any one of claims 2 to 4, wherein: slide restricting means is provided to restrict free movement of the upper center punch relative to the upper outer punch; and the upper center punch has a part allowing the upper center punch and the upper outer punch turned into one unit by the slide restricting means to be guided by the guide means of the upper outer punch.

9. A double-structure punch for use in a rotary compression molding machine, comprising: a center punch and an outer punch around the center punch, both of which are slidable and capable of pressing, the center punch having a head part configured to be capable of projecting from a head part of the outer punch; and engagement means for causing the center punch to engage the outer punch with the head part of the center punch in a state projecting maximally from the head part of the outer punch to allow both the punches to operate together as one unit.

10. The double-structure punch for the use in the rotary compression molding machine in accordance with claim 9, wherein: the outer punch has a peripheral surface with an opening; and center punch positioning means projecting through the opening is provided, which is capable of guiding the center punch by external guide means.

11. The double-structure punch for the use in the rotary compression molding machine in accordance with claim 9 or 10, wherein the engagement means comprises a center punch engaging part located adjacent to the center punch head part for engaging the outer punch, and an outer punch engaging part located at the outer punch for engaging the engaging part of the center punch.

12. The double-structure punch for the use in the rotary compression molding machine in accordance with claim 9 or 10, wherein slide restricting means is provided to restrict free movement of the center punch relative to the outer punch.

13. A center punch for use in a double-structure punch of a rotary compression molding machine, comprising a head part capable of projecting from a head part of an outer punch, an engaging part located adjacent to the head part for engaging the outer punch, and a projecting part formed at a peripheral surface of the center punch, the projecting part constituting positioning means capable of being guided by external guide means.

14. A compression roll characterized by comprising a pressing surface with a groove.
